(19) United States
(12) Patent Application Publication
(10) Pub. No.: US 2007/0127995 A1
(43) Pub. Date: Jun. 7, 2007

(54) End mill cutting method for hard brittle material

(75) Inventors: Takashi Matsumura, Chiyoda-ku (JP); Takenori Ono, Arakawa-ku (JP); Naoki Yajima, Kitaadachi-gun (JP)

Correspondence Address: NDQ&M WATCHSTONE LLP, 1300 EYE STREET, NW, SUITE 1000 WEST TOWER, WASHINGTON, DC, 20005, US

(73) Assignee: Tokyo Denki University, Tokyo (JP)

(21) Appl. No.: 10/570,201

(22) PCT Filed: Sep. 2, 2004
(86) PCT No.: PCT/JP04/12731

§ 371 Date: Sep. 25, 2006

(30) Foreign Application Priority Data
Sep. 2, 2003 (JP) 2003-310494
Mar. 15, 2004 (JP) 2004-073020

(51) Int. Cl. B23C 3/00

(52) U.S. Cl. 409/132; 409/136

(57) ABSTRACT

A groove having a depth greater than 1 μm is efficiently cut out on glass as a work by use of a super-hard ball end mill. A groove having a depth equal to or above 1 μm is formed on a work made of a glassy inorganic material or a hard, brittle material by one session of cutting operation without generating damage while rotating a ball end mill at a high speed. A rotating shaft of the ball end mill has a relative tilt angle in a feeding direction of the ball end mill with respect to a cutting surface of the work when subjecting the work to cutting while rotating the ball end mill at a high speed. In this way, a cutting groove having a width of 200 μm and a depth of 20 μm is formed on a glass substrate as the work by one session of cutting operation.

### BACKGROUND OF THE INVENTION

1. Field of the Invention

This invention relates to an end mill cutting method for a hard, brittle material using either a ball end mill or a square end mill. More specifically, this invention relates to an end mill cutting method for a hard, brittle material configured to perform micro-groove cutting on works including glassy inorganic materials such as glass, and hard, brittle inorganic materials such as single crystal silicon.

2. Description of the Related Art The micro TAS (total analysis systems), which is also known as the “Lab on a chip” technology, is widely used in many scenes including chemical, pharmaceutical, medical fields and the like in recent years. A technique to perform micro-groove cutting and other works on substrate materials such as a glassy inorganic material has become important.

Conventionally, an etching process using chemicals such as hydrofluoric acid has been known as a method of performing micro-groove cutting and other works. However, such a chemical processing method poses the following problems.

The use of strong acid chemicals requires careful attention to proper handling under a licensed person, and a waste liquid treatment after working in order to prevent an environmental problem. Accordingly, this method causes costs in consideration of safety measures.

On the other hand, a low-concentrated hydrofluoric acid solution is frequently used in light of safety. However, the use of the low-concentrated hydrofluoric acid solution consumes a long time period for the processing treatment such as a whole day. Accordingly, the use of the low-concentrated hydrofluoric acid constitutes an obstacle to shortening the process time.

Moreover, a masking member is necessary for forming required grooves. A masking work is time-consuming and therefore causes reduction in operating efficiency.

Meanwhile, instead of the above-described etching process using the chemicals, a method of cutting desired grooves while rotating an end mill, or in other words, end mill cutting is carried out as a mechanical cutting method. An end mill is fitted to a spindle of a machining center. The end mill is rotated by the spindle and cuts out a work three-dimensionally along the X-axis, the Y-axis, and the Z-axis relatively to the work.

The end mill cutting includes ball end mill cutting and square end mill cutting. A ball end mill 101 has a shape as shown in FIG. 1, while a square end mill 113 has a shape as shown in FIG. 3.

In the conventional ball end mill cutting, a cutting blade 109 incises the work 105 with a rotating shaft 103 of the ball end mill 101 being almost orthogonal to a cutting surface 107 of a work 105 and, the ball end mill 101 is fed in a direction of an arrow as shown in FIG. 1. In terms of a cutting blade 109 of the ball end mill 101, a biting point A of the cutting blade 109 having a small cutting depth as indicated with a solid line in FIG. 2 and a departure section B of the cutting blade 109 fed in a direction of an arrow and indicated with a chain double-dashed line in FIG. 2 are the portions that form a finished surface of a cutting groove 111. Other portions will be removed as chips in a later cutting process. Here, FIG. 2 illustrates an aspect in which the cutting blade 109 at the biting point A is rotated and fed to the departure section B and the ball end mill 101 is fed from a position illustrated with a solid line to a position illustrated with a chain double-dashed line in this period.

Meanwhile, in the conventional square mill cutting, a cutting blade 117 incises the work 105 with a rotating shaft 115 of the square end mill 113 being almost orthogonal to the cutting surface 107 of the work 105 as shown in FIG. 3. Subsequently, the square end mill 113 is fed in a direction of an arrow almost in parallel to the cutting surface 107 as similar to the case shown in FIG. 2. The cutting mechanism is achieved in accordance with the relation between the biting point A and the departure section B as similar to the above-described ball end mill cutting.

In general, diamond is used as a tool material for cutting glass as the work 105. When a cutting depth is equal to or below 1 μ, the glass is subjected to ductile deformation as similar to a case of metal cutting as disclosed in Japanese Patent Application Laid-open No. Hei9(1997)-155617. In this way, it is possible to obtain a cutting surface without brittle damage.

However, in the case of cutting glass with bites in accordance with the conventional technique, the glass is cut out favorably while generating chips like shaving when the cutting depth CD is equal to or below 1 μm. On the contrary, the glass breaks up if the cutting depth exceeds 1 μm. For this reason, in order to cut the glass in the micrometer order, a cutting process configured to cut only in the depth not exceeding 1 μm in one session by use of a sharp-pointed diamond R bite is applied. Such a method leads to a problem of poor workability.

Meanwhile, a ball end mill made of diamond is about ten times as expensive as the ball end mill 101 or the square end mill 113 made of a super-hard alloy. Therefore, the diamond ball end mill leads to a problem of high-cost.

Moreover, in the conventional ball end mill cutting, the ball end mill 101 having a curvature radius R cuts the vicinity of the cutting surface by use of a turning radius r1 of the cutting blade 109. On the contrary, a turning radius of the cutting blade 109 in the center of the rotating shaft 103 of the ball end mill 101 is equal to zero (0). Accordingly, a place near the center of the rotating shaft 103 is cut out by use of a small turning radius r2 of the cutting blade. Therefore, there has been a problem that a cutting speed slows down and cutting workability is reduced as a consequence.

### SUMMARY OF THE INVENTION

This invention has been made to solve the foregoing problems.

A ball end mill cutting method of this invention includes a step of cutting a groove having a depth equal to or above 1 μm on a work made of any of a glassy inorganic material and a hard, brittle inorganic material without causing damage by one session of a cutting operation, while rotating a super-hard ball end mill including a cutting blade having roundness and a spiral angle.

In the ball end mill cutting method of this invention, a rotating shaft of the ball end mill preferably has a relative tilt angle in a feeding direction of the ball end mill with respect to a cutting surface of the work.

Moreover, in the ball end mill cutting method of this invention, the cutting operation is preferably performed in water.

Further, in the ball end mill cutting method of this invention, the tilt angle of the ball end mill is preferably set in a range equal to or above a tilt angle defined by causing a circle line of edge of a curvature radius of the ball end mill to intersect the cutting surface but within 90°, when a peripheral surface of the cutting blade of the ball end mill is located at a given cutting depth.

Meanwhile, in the ball end mill cutting method of this invention, the tilt angle of the ball end mill is preferably set to 45°, a rotating speed is preferably set substantially to 20000 rpm, and a feed speed is preferably set in a range from 1 to 8 μm/sec.

Furthermore, in the ball end mill cutting method of this embodiment, the curvature radius of the ball end mill is preferably set to 200 μm, and the cutting depth is preferably set in a range from 15 to 20 μm.

A square end mill cutting method of this invention includes a step of cutting a work made of any of a glassy inorganic material and a hard, brittle inorganic material without causing damage, while rotating a super-hard ball end mill including cutting blades each having a rectangle and a spiral angle at a feed speed for each of the cutting blades in a range from 4.8 to 6 nm/edge.

In the square end mill cutting method of this invention, the feed speed is preferably set equal to or below 0.24 mm/min, when a rotating speed of the square end mill is set to 20000 rpm.

Meanwhile, in the square end mill cutting method of this invention, a rotating speed is preferably set equal to or above 50000 rpm, when the feed speed is set to 0.48 mm/min.

Moreover, in the square end mill cutting method of this invention, the square end mill preferably includes a cubic boron nitride (cBN) tool.

As is understood from the above-described means for solving the problems, according to the ball end mill cutting method of this invention, it is possible to cut micro-grooves each having a depth in a range from 15 to 20 μm and a width approximately equal to 200 μm, for example, efficiently in one session on a work made of a glassy inorganic material or a hard, brittle inorganic material. As a result, productivity is increased by approximately 20 times as high as the conventional technique. Moreover, the ball end mill made of a super-hard alloy costs about 1/10 of an end mill with diamond. Therefore, cost reduction in a scale of about 1/200 is expected in terms of both of productivity and the cost of the tool.

Meanwhile, according to the square end mill cutting method of this invention, when cutting micro-channels having rectangular cross sections on a glass substrate, it is possible to obtain an excellent cutting surface without brittle damage by feeding each blade of the square end mill at a speed in a range from 4.8 to 6 nm/edge

Here, when a cutting distance becomes longer, an adverse effect on the cutting surface is increased due to abrasion of the tool. However, a cBN tool has superior abrasion resistance to a super-hard ally tool in light of groove cutting on glass. Accordingly, by use of the cBN tool, it is possible to execute stable cutting operations over a longer distance.

### BRIEF DESCRIPTION OF THE DRAWINGS

FIG. 1 is a schematic view for explaining a conventional ball end mill cutting principle.

FIG. 2 is a plan view relevant to FIG. 1.

FIG. 3 is a schematic view for explaining conventional square end mill cutting.

FIG. 4 is a schematic view for explaining a ball end mill cutting principle according to a first embodiment of this invention.

FIG. 5 is another schematic view for explaining the ball end mill cutting principle according to the first embodiment.

FIG. 6 is still another schematic view for explaining the ball end mill cutting principle according to the first embodiment.

FIG. 7 is a partial perspective view of a machining center used as a cutting apparatus in the first embodiment.

FIG. 8 is a partially enlarged plan view showing a cutting example of asperity fabricated in accordance with a ball end mill cutting method of the first embodiment.

FIG. 9 is a perspective view showing a profile of a groove of the asperity in FIG. 8.

FIG. 10 is a schematic view for explaining square end mill cutting according to a second embodiment of this invention.

FIG. 11 is a plan view relevant to FIG. 10.

FIG. 12 is a graph showing a total area of brittle damage relative to a feed speed for a square end mill cutting tool when revolutions of the tool are set to 20000 rpm.

FIG. 13 is a graph showing a total area of brittle damage relative to the revolutions of the tool when the feed speed for the square end mill cutting tool is set to 4.8 mm/min.

FIGS. 14A, 14C, and 14D are plan views and FIG. 14B is a cross-sectional view showing a cutting example of asperity fabricated in accordance with a square end mill cutting method.

FIGS. 15A and 15B are cross-sectional views of a channel shown in FIG. 14D, in which FIG. 15A is a cross-sectional view showing a starting point of cutting and FIG. 15B is a cross-sectional view showing an ending point.

FIG. 16A is a plan view of groove shapes at starting points of cutting and at cutting distances of 50 mm, and FIG. 16B is a graph showing edges lost in terms of various tools.

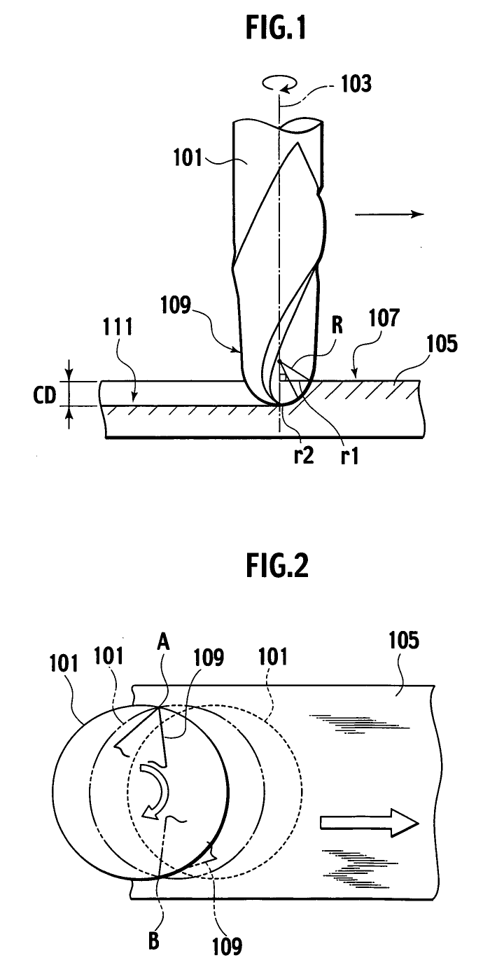

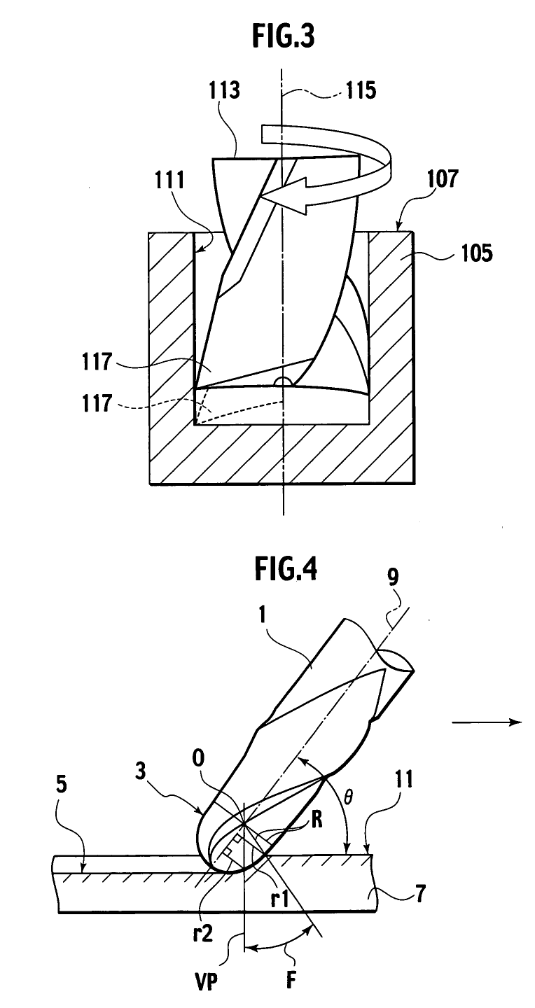

### DETAILED DESCRIPTION OF THE PREFERRED EMBODIMENTS

Embodiments of this invention will be described below with reference to the accompanying drawings.

As shown in FIG. 4, in terms of a cutting principle with a ball end mill 1 according to a first embodiment of this invention, the ball end mill 1 includes a cutting blade 3 having an obtuse and spiral angle. Moreover, portions for forming a finished surface of a cutting groove 5 are a biting point A of the cutting blade 3 having a small cutting depth indicated with the solid line in FIG. 2 and a departure section B of the cutting blade 3 indicated with the chain double-dashed line in FIG. 2 as described previously in terms of two dimensions along the X-axis and the Y-axis. Other portions will be removed as chips in a later cutting process. Therefore, in the course of end mill cutting of glass as a work 7, an appropriate feed speed and revolutions are set up to control the cutting depths of the biting point A and the departure section B of the cutting blade 3 for creating the finished surface in the submicron order. In this way, it is possible to cut out the glass ductilely. In other words, the mechanism of the end mill cutting is to set the cutting depth of a material for cutting out the finished surface with the cutting blade 3 equal to or below 1 μm in order to avoid cracks on the glass.

The cutting process using the ball end mill 1 of this embodiment is a result of three-dimensional extension by adding the Z-axis to the above-described cutting principle. That is, the cutting blade 3 of the ball end mill 1 has a curvature radius R in the Z-axis direction. Therefore, a cutting speed of the ball end mill 1 becomes small at a bottom of the cutting groove 5 and is increased along with the height of the cutting blade 3. A bottom part of the ball end mill 1 creates a cutting finished surface (also referred simply as a finished surface or a finished surface as a product) of a central part of the groove. As the height of the cutting blade 3 is increased, a cutting finished surface ranging from a side face to an edge of the groove is created. Therefore, it is possible to cut the work 7 such as a glassy inorganic material or a hard, brittle inorganic material ductilely by setting appropriate cutting conditions.

However, when a rotating shaft 9 of the ball end mill 1 strikes a cutting surface 11 of the work 7 almost orthogonally, the curvature radius of the cutting blade 3 becomes small in the vicinity of the center of the rotating shaft 9. Therefore, a cutting speed slows down and cutting workability is reduced as a consequence. Accordingly, this embodiment is configured to incline the rotating shaft 9 of the ball end mill 1 relative to the cutting surface 11 of the work 7 by a tilt angle θ in the feeding direction as shown in FIG. 4, and thereby to cut the bottom part of the cutting groove 5 while retaining a certain cutting speed. It is possible to cut the work 7 by setting the rotating shaft 9 of the end mill 1 at a tilt angle θ of 90°, i.e. at a right angle relative to the cutting surface 11 of the work 7. However, it is desirable to provide the tilt angle θ in order to ensure the cutting speed.

To be more in detail, when the above-described tilt angle θ is provided as shown in FIG. 4, a usage range F of the cutting blade 3 of the ball end mill 1 actually used for cutting has a range from a perpendicular plane VP that passes through a center O of the curvature radius R of the ball end mill 1 and orthogonally intersects the cutting surface 11 of the work 7 and the feeding direction of the ball end mill 1 to the cutting surface 11 of the work 7 on the side of the feeding direction. Therefore, a large cutting speed is brought about on the cutting surface 11 of the work 7 due to a turning radius r1 of the cutting blade 3, and meanwhile, a cutting speed attributed to a turning radius r2 of the cutting blade 3 is maintained at the bottom part of the cutting groove 5. Here, the cutting speed attributed to the turning radius r2 is increased as the above-described tilt angle θ is decreased.

Aside from the difficult operability caused by inclining the ball end mill 1, the above-described tilt angle θ might be set even smaller. In this case, as shown in FIG. 5, it is possible to define a tilt angle θ1 representing inclination of a circle line of edge EL of the curvature radius R in terms of the ball end mill 1 that intersects the cutting surface 11 of the work 7 when a peripheral surface of the cutting blade 3 of the ball end mill 1 is located at a given cutting depth CD. In this state, the cutting speed reaches the maximum as the turning radius of the cutting blade 3 becomes equal to the curvature radius R on the cutting surface 11 of the work 7. At the same time, the cutting speed reaches the maximum at the bottom part of the cutting groove 5 due to a turning radius r3 of the cutting blade 3.

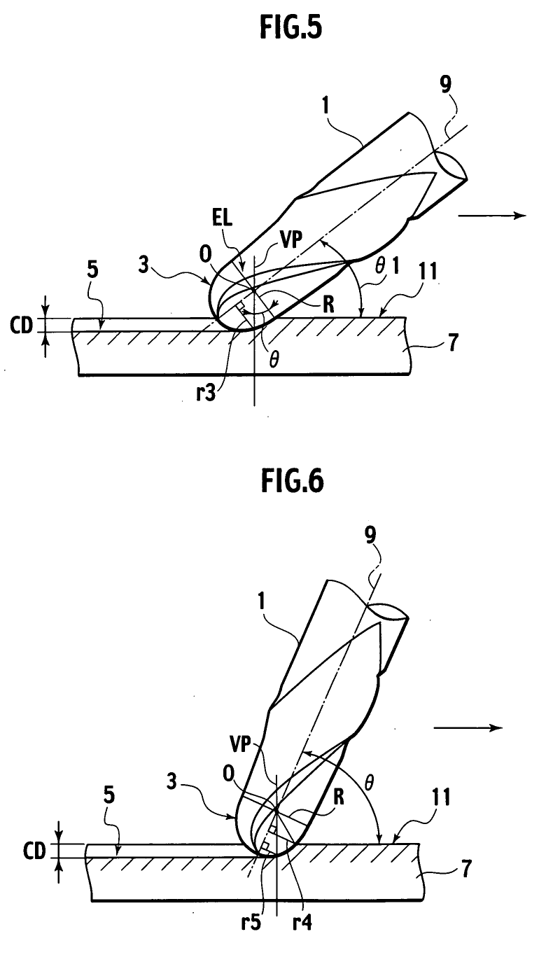

Meanwhile, when the tilt angle θ is increased, the cutting speed attributed to a turning radius r4 of the cutting blade is reduced on the cutting surface 11 of the work 7 as shown in FIG. 6, and the cutting speed attributed to a turning radius r5 of the cutting blade 3 is reduced at the bottom part of the cutting groove 5.

From these facts, an applicable range of the tilt angle. θ of the rotating shaft 9 of the ball end mill 1 should satisfy an inclination in the feeding direction at an angle equal to or above the above-described tilt angle θ1. For example, in terms of FIG. 5, if the curvature radius R of the ball end mill 1 is equal to 200 μm and the cutting depth CD is equal to 20 μm, the minimum tilt angle θ1 is expressed as cos θ1=(200−20)/200, i.e. the tilt angle θ is approximately equal to 26°. The applicable range of the tilt angle θ at this time is expressed as 26°=θ<90°. Note that the optimal tilt angle θ is set up in view of various cutting conditions including the revolutions of the ball end mill 1, the feed speed, the cutting depth, the curvature radius R, operability (working efficiency), and the like.

Meanwhile, since the mechanical strength of the glass is reduced in water, it is preferable to subject the glass to ball end mill cutting in water to improve a cutting performance.

Next, a working characteristic test performed based on the above-described cutting principle will be described.

A machining center 13 serving as a cutting apparatus includes a spindle attachment 17 which is attached to a lower part of a spindle head 15. Moreover, a brushless motor spindle 19 capable of achieving maximum revolutions of 80000 rpm is fitted to this spindle attachment 17 with a spindle cramp 21 so as to set up the tilt angle θ arbitrarily. In this test, the ball end mill 1 made of a super-hard alloy is applied.

The super-hard ball end mill 1 is fitted to the spindle 19 and movements in the X-axis and Y-axis directions are performed by use of a servo mechanism in the machining center 13. Accordingly, the spindle 19 can be inclined arbitrarily in the two-dimensional directions along the X-axis and the Y-axis. Therefore, the ball end mill 1 can be arbitrarily inclined likewise.

A stage 23 driven by a stepping motor having a resolution of 0.3 μm is used for setting a cut in the Z-axis direction. Specifically, this stage 23 is movable in the X-axis and Y-axis directions by use of servo motors, while the spindle head 15 is movable in the Z-axis direction. The stage 23 is placed on a palette 25 of the machining center 13. Here, the glass as the work 7 is retained in a water bath 27 on the stage 23 so as to enable cutting in water.

The super-hard ball end mill 1 is fitted to the spindle 19, while the spindle 19 is inclined in the X-axis and Y-axis directions so as to define the tilt angle θ of 45°, for example. Then, a cutting test is performed by use of the super-hard ball end mill 1 having the curvature radius R of 0.2 mm or 0.25 mm, for example.

First, as a result of groove cutting while setting the revolutions of the ball end mill 1 equal to 80000 rpm and the feed speed equal to 1 μm/sec, weld deposits of chips in a cutting groove 5 are increased. It is therefore apparent that a cutting temperature is too high at the revolutions of 80000 rpm. In addition, a tool damage state of the ball end mill 1 is observed after cutting and it is found out that the cutting blade 3 is excessively worn away. Therefore, it is obvious that the cutting conditions of the revolutions at the 80000 rpm and the feed speed at the 1 μm/sec are not appropriate.

Accordingly, a cutting surface condition is evaluated while reducing the revolutions. As a result, it is found out that a surface of the cutting groove is in the best condition at the revolutions of 20000 rpm. Moreover, at the revolutions of 20000 rpm, the cutting depth in the Z-axis direction is set to 18 μm while changing the feed speed. Comparing the state of cutting surface of each feed speed with the cutting depth of 18 μm and the revolutions of 20000 rpm, effects of the respective feed speeds to the cutting surface are investigated. As a result, it is found out that the maximum feed speed that can avoid brittle damage on an edge portion of the cutting groove 5 is equal to 8 μm/sec. Therefore, at least in this embodiment, favorable results are obtained at the feed speed in the range from 1 to 8 μm/sec in terms of the revolutions of 20000 rpm.

To improve analytic accuracy of a DNA (deoxyribo nucleic acid) microarray, it is essential to ensure a constant amount of cDNA (complimentary DNA) or oligo DNA to be attached to a test area. Based on this demand, micro asperity having a certain area is fabricated by forming the cutting grooves 5 having the depth in a range from 15 to 20 μm at constant pitches in the X-axis and Y-axis directions.

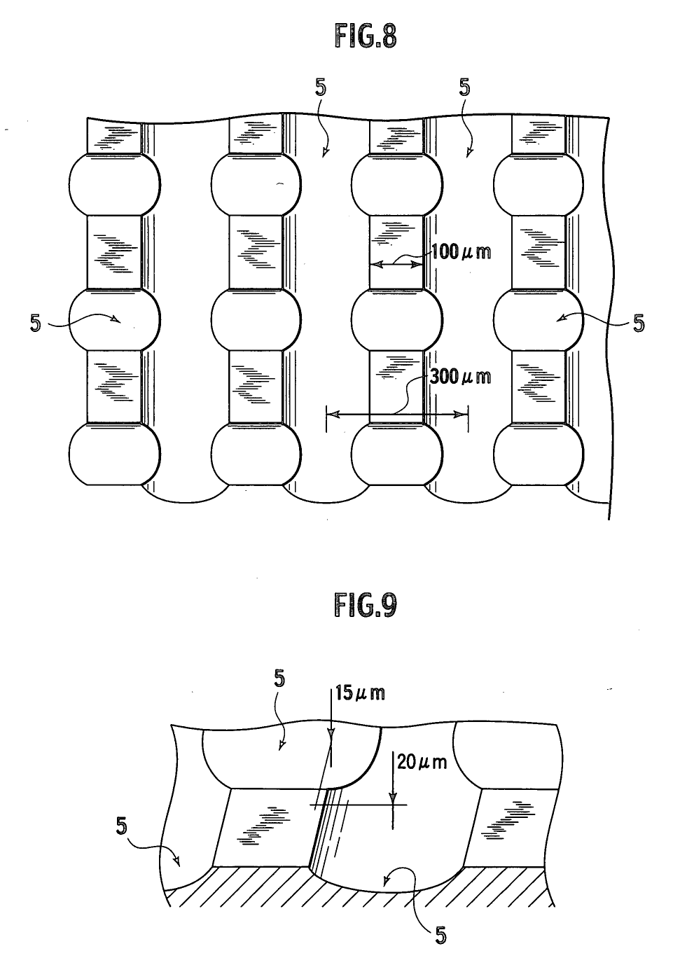

FIG. 8 and FIG. 9 collectively show an example of forming 100 pieces of asperity arrayed in a 10×10 matrix. FIG. 8 shows a partially enlarged view thereof, in which fine cutting surfaces are achieved in terms of the respective pieces of asperity. FIG. 9 shows a profile of a groove portion in the asperity shown in FIG. 8. Here, a favorable finished surface as shown on a lower side in the FIG. 9 is obtained. In FIG. 8, the cutting depth of the cutting grooves 5 on the vertical line is equal to 20 μm, while the cutting depth of the cutting grooves 5 on the horizontal line is equal to 15 μm. Meanwhile, a space between the cutting grooves 5 on the vertical line is equal to 300 μm.

From these facts, adequacy of the cutting principle for micro-grove cutting on the glass by use of the ball end mill 1 is obvious. Moreover, as a result of the cutting test, it is confirmed that the appropriate revolutions of the ball end mill 1 are equal to 20000 rpm, and that the appropriate tool feed speed is equal to 8 μm/sec.

Meanwhile, the utility of the ball end mill cutting method of this embodiment is apparent from the result of fabricating the micro asperity. In this example, the micro cutting grooves 5 having the depth in the range from 15 to 20 μm and the width around 200 μm on the glass are cut efficiently in one session by use of the ball end mill 1 made of the super-hard alloy. Accordingly, it is possible to improve productivity approximately 20 times as high as the conventional technique. Moreover, the ball end mill 1 made of the super-hard alloy only costs about 1/10 of a diamond end mill. Therefore, cost reduction in a scale of about 1/200 is expected from this embodiment in terms of both of productivity and the cost of the tool.

In the process of performing the above-described cutting test, the ball end mill 1 having the curvature radius R of 200 μm and the ball end mill 1 having curvature radius R of 250 μm are used separately. In fact, similar effects are obtained by use of the ball end mills 1 having other arbitrary curvature radii R.

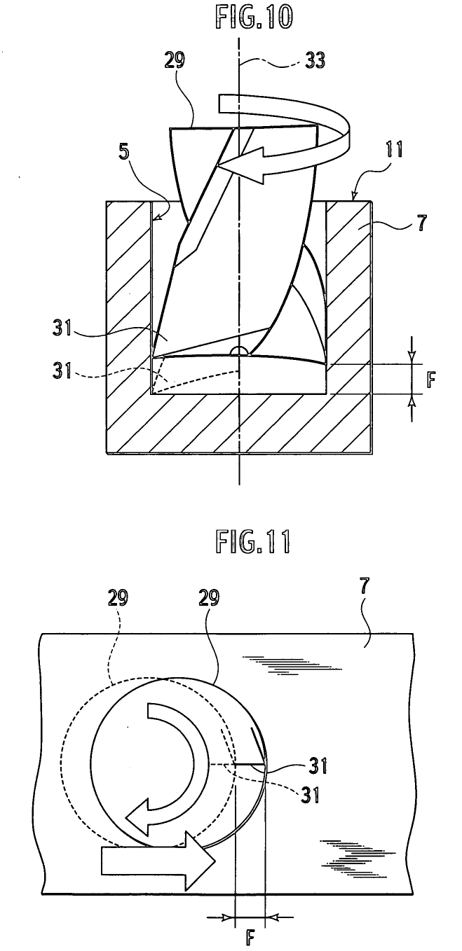

Next, a square end mill cutting method according to a second embodiment of this invention will be described with reference to the accompanying drawings. Referring to FIG. 10 and FIG. 11, a cutting blade 31 of a square end mill 29 (hereinafter simply referred to as a “tool”) has a rectangle and a spiral angle as shown in FIG. 10, and cuts out the work 7 with a rotating shaft 33 thereof being almost orthogonal to the cutting surface 11 of the work 7. The tool is fed in a direction of an arrow as shown in FIG. 11. That is, the cutting process by the square end mill 29 includes a step of cutting the glass as the work 7 in a depth direction of a channel by use of the square end mill 29, and a step of feeding the square end mill 29 in a lateral direction. Here, as shown in FIG. 2, the cutting mechanism is achieved in accordance with the relation between the biting point A and the departure section B as similar to the above-described ball end mill cutting.

In this square end mill cutting, a feed F (Feed/edge) for each cutting blade 31 is equivalent to the maximum cutting depth as shown in FIG. 10 and FIG. 11. Meanwhile, the glass generates chips similar to metal when the cutting depth is set equal to or below 1 μm. In this way, it is possible to cut the glass without causing brittle cracks.

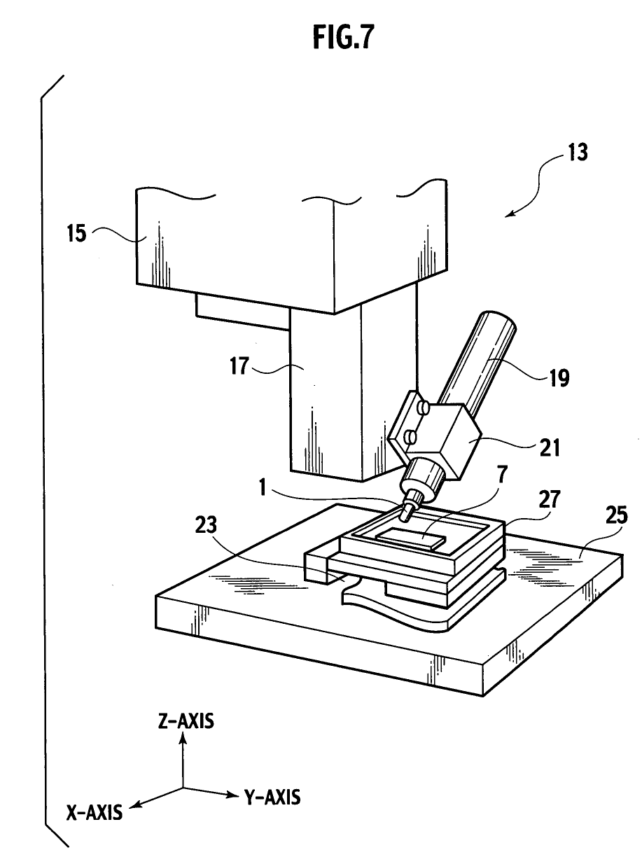

Therefore, in the square end mill cutting, it is possible to obtain a cutting surface without brittle damage by setting the feed F for each cutting blade 31 equal to or below 1 μm. This embodiment is configured to cut out the groove 5 while setting the cutting depth in an axial direction of the square end mill 29 equal to several tens of micrometers. Here, the cutting surface without brittle damage is obtained by cutting the glass while setting the maximum cutting depth to be removed by each cutting blade 31 in accordance with a ductile cutting condition of the glass, with the revolutions and the feed speed being set appropriately. However, it is necessary to reduce the feed F for each cutting blade 31 substantially smaller than 1 μm in consideration of brittle damage attributable to a variation in the stress state at the time of biting and departing of the cutting blade in the cutting process of the square end mill 29. Therefore, a cutting characteristic test is carried out under various conditions in order to obtain a proper feed speed for each cutting blade 31 in the square end mill cutting. Here, the machining center 13 shown in FIG. 7 is used as the cutting apparatus.

In this cutting characteristic test, the work 7 is retained in the water bath 27 so as to supply a cutting fluid sufficiently. Moreover, feeding in the X-axis and Y-axis directions is driven by the servo mechanism of the machining center 13, and the cutting in the Z-axis direction is driven by the stepping motor having the resolution of 0.3 μm.

This embodiment applies the super-hard square end mill 29 including two TiAlN(titanium aluminum nitride)-coated blades and having a diameter of 0.3 mm. Fabrication of micro channels having rectangular cross sections are attempted on crown glass which is commonly used as a glass slide. Then a state of brittle damage at a groove edge portion is observed.

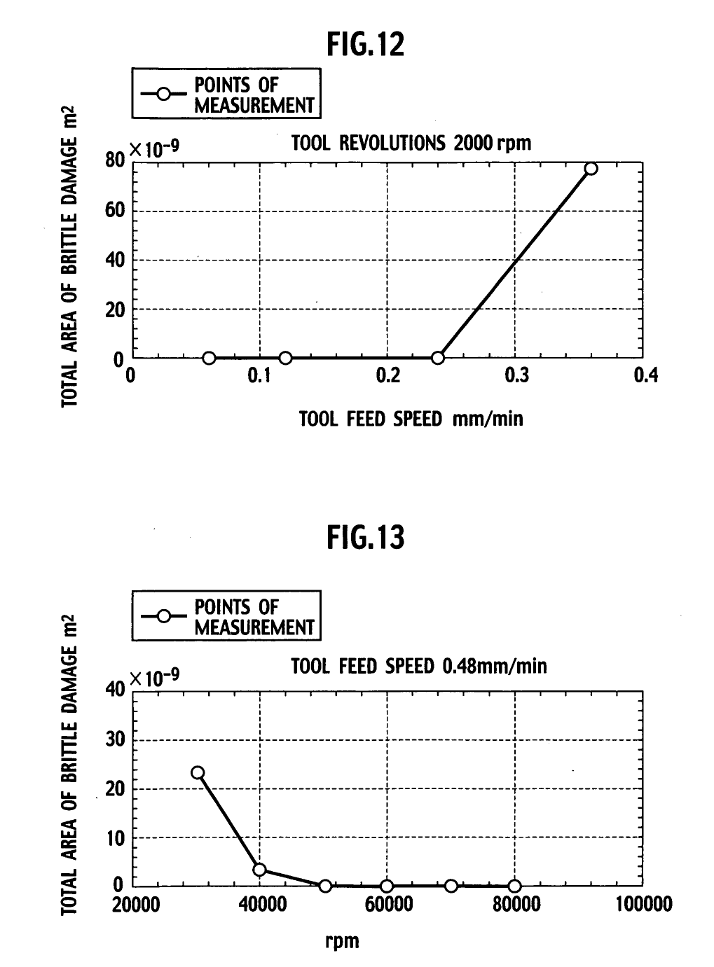

As shown in FIG. 12, to investigate effects of the tool feed speed to the cutting surface, the revolutions of the tool are set to a constant value of 20000 rpm while changing the tool feed speed in a range from 0.06 to 0.36 mm/min. In this way, total areas of brittle damage generated at the groove edge portion are compared among the respective tool feed speeds. As a result, the size and the number of brittle damage observed at the groove edge portion are increased along with an increase in the feed speed. Specifically, a significant amount of brittle damage is confirmed at the tool feed speed of 0.36 mm/min. In this case, the cutting surface seems favorable when the tool feed speed is set equal to or below 0.24 mm/min.

As shown in FIG. 13, to investigate effects of the revolutions of the tool to the cutting surface, the tool feed speed is set to a constant value of 0.48 mm/min while changing the revolutions of the tool in a range from 30000 to 80000 rpm. In this way, total areas of brittle damage generated at the groove edge portion are compared among the respective revolutions of the tool. As a result, although brittle damage is generated at the low revolutions of 30000 rpm, a favorable cutting surface without brittle damage is obtained at the high revolutions equal to or above 50000 rpm because the feed speed for each cutting blade is reduced along with the increase in the revolutions.

From these two kinds of results, it is conceivable that the presence of brittle damage is largely attributed to the influence of the feed F for each cutting blade 31. Accordingly, another test is executed to find out an appropriate feed speed for each cutting blade 31 for obtaining the favorable cutting surface while setting various tool revolutions and tool feed speeds. As a result, it is made clear that the feed speed for each blade 31 is preferably set in a range from 4.8 to 6 nm/edge in order to achieve the cutting without generating brittle damage.

### EXAMPLES

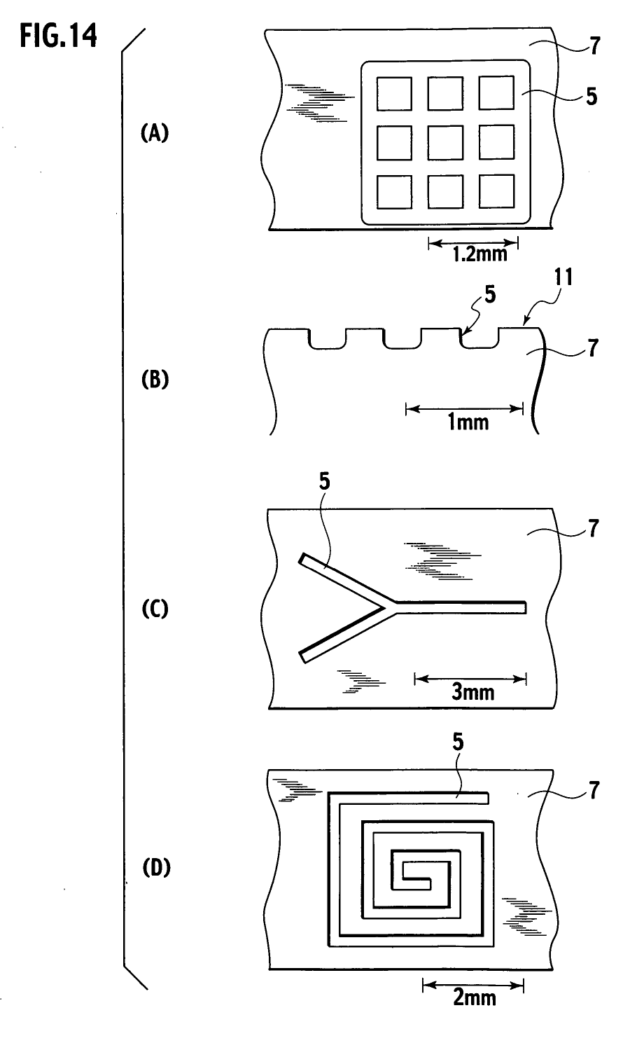

Today, Pyrex (registered trademark) or fused silica glass is generally used for glass substrates in medical and other research institutes. Accordingly, in this embodiment, formation of micro channels on glass substrates made of Pyrex (registered trademark) with the square end mill 29 is attempted as shown in FIGS. 14A to 14D. In terms of the cutting conditions, the revolutions of the tool are set to 20000 rpm and the tool feed speed is set to 0.12 mm/min. The glass substrates are cut out in water.

FIG. 14A shows an example of cutting micro asperity in a 3×3 matrix while providing 4 channels of the cutting grooves 5 having the depth of 20 μm respectively along the vertical line (an up-and-down direction in the drawing) and the horizontal line (a left-to-right direction in the drawing) so as to intersect one another at right angles.

FIG. 14B shows an example of cutting channels of the cutting grooves 5 each having the width of 0.3 mm and the depth of 0.1 mm. Here, the cutting groove 5 having the depth of 0.1 mm is formed by repeating the cutting works along the axial direction at the depth of 20 μm five times.

FIG. 14C shows an example of cutting a Y-shaped channel of the cutting groove 5 having the depth of 20 μm which is assumed to be used for a micro reactor. FIG. 14D shows an example of forming a whorled channel of the cutting groove 5 having the depth of 30 μm.

Although fine cutting surfaces without brittle damage are obtained in any cases shown in FIGS. 14A to 14d at the starting point of cutting, the widths and the depths of the cutting grooves 5 are gradually reduced along with cutting distances.

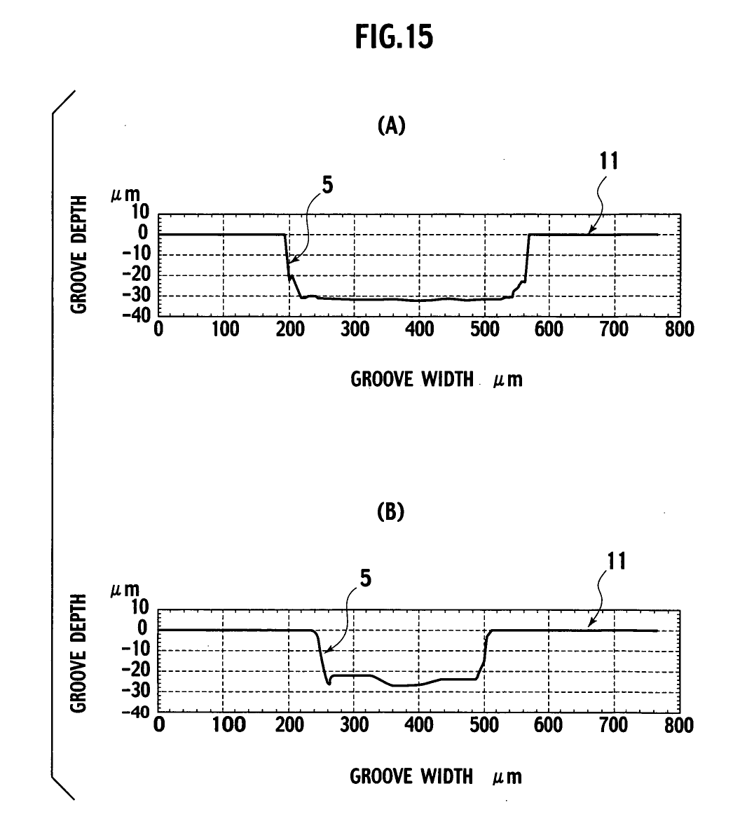

For example, cross sections at the starting point of cutting and an ending point in terms of the channel shown in FIG. 14D are measured with a laser microscope. FIG. 15A shows the cross section at the starting point of cutting and the FIG. 15B shows the cross section at the ending point of cutting. These drawings are compared with each other at the same scale. As it is apparent from these drawings, the width and the depth of the cutting groove 5 are gradually decreased along with the cutting distance, and a central portion of a groove bottom becomes deeper as compared to other portions. At the starting point of cutting, the cutting groove has the width approximately equal to 370 μm and the depth approximately equal to 32 μm. Meanwhile, at the ending point, the cutting groove has the width approximately equal to 250 μm and the depth approximately equal to 22 to 24 μm.

Such a change in the cross-sectional shape is attributable to abrasion of side blades and bottom blades of the square end mill 29. Moreover, a peripheral portion of the bottom blade of the square end mill 29 is worn away faster than a central portion thereof because the peripheral portion has a faster cutting speed than that of the central portion. Accordingly, as the cutting distance is extended, the cut at the central portion of the bottom blade grows relatively larger than that at other portions as shown in FIG. 15B. In short, it is apparent from this example that abrasion of the tool has a large influence to the cutting surface.

Therefore, in this embodiment, a cutting test is executed by use of the square end mills 29 respectively applying four types of tool materials, namely, a super-hard alloy, a TiAlN-coated super-hard alloy, a DLC (diamond-like-carbon)-coated super-hard alloy, and cBN in order to examine an appropriate material of the tool. Abrasion resistance characteristics of these tools are compared by means of measuring the groove cutting surfaces. In terms of the cutting conditions, the tool feed speed is set to 0.24 mm/min, the revolutions of the tools are set to 20000 rpm, and the cutting depth in the axial direction is set to 20 μm. The cutting is performed in water in each case.

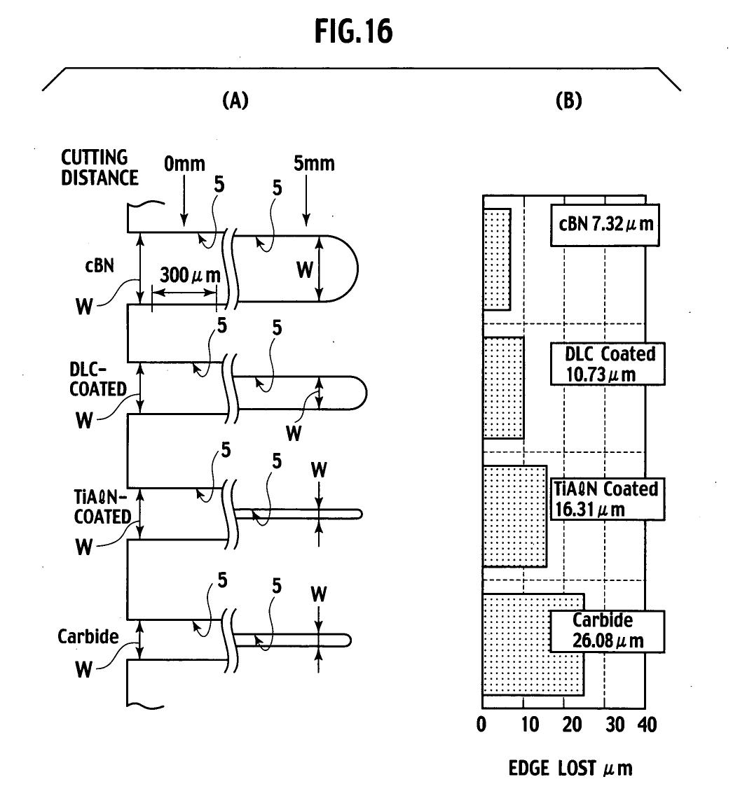

As a result of comparing the shapes of the groves 5 at the starting point of cutting and at a distance of 50 mm, the cBN tool shows the smallest change in the groove width W as shown in FIG. 16A, and the amounts of change in the groove width grow larger in the order of the DLC-coated super-hard alloy, the super-hard alloy, and the TiAlN-coated super-hard alloy.

Meanwhile, as shown in FIG. 16B, in terms of the edge lost of the cutting blade 31 in a position at a radius of 90 μm of the bottom blade of the square end mill 29, the cBN tool shows the smallest amount of 7.32 μm, and subsequently, the edge lost is gradually increased in the order of the DLC-coated super-hard alloy in the amount of 10.73 μm, the TiAlN-coated super-hard alloy in the amount of 16.31 μm, and the super-hard alloy in the amount of 26.08 μm.

It is apparent from the foregoing that, in terms of the amounts of change in the cutting groove width W and the amounts of edge lost along with cutting distances, the cBN tool has excellent abrasion resistance among the four types of the tool materials being compared.

As described above, in the square end mill cutting, it is possible to obtain an excellent cutting surface without brittle damage by setting the feed F in the range from 4.8 to 6 nm for each cutting blade 31 when cutting the micro channels having the rectangular cross sections on the glass substrate. Moreover, the influence of abrasion of the tool to the cutting surface grows larger along with the increase in the cutting distance. In this regard, the cBN tool has superior abrasion resistance to the super-hard alloy tools.

It is to be noted that this invention will not be limited only to the above-described embodiments. Various other embodiments are possible by applying appropriate modifications.

Various applications are expected from this invention. Such applications include a low-cost and efficient prototype of a chemical analyzer called the “micro TAS” which is integrated in the size of a prepared slide, a prototype or a practical application of a microscopic-pattern “mold material”made of glass, and the like.

1. A ball end mill cutting method comprising a step of:
cutting a groove having a depth equal to or above 1 μm on a work made of any of a glassy inorganic material and a hard, brittle inorganic material without causing damage by one session of a cutting operation while rotating a super-hard ball end mill including a cutting blade having roundness and a spiral angle.

2. The ball end mill cutting method according to claim 1,
wherein a rotating shaft of the ball end mill has a relative tilt angle in a feeding direction of the ball end mill with respect to a cutting surface of the work.

3. The ball end mill cutting method according to any one of claims 1 and 2,
wherein the cutting operation is performed in water.

4. The ball end mill cutting method according to any one of claims 2 and 3,
wherein the tilt angle of the ball end mill is set in a range equal to or above a tilt angle defined by causing a circle line of edge of a curvature radius of the ball end mill to intersect the cutting surface and within 90°, when a peripheral surface of the cutting blade of the ball end mill is located at a given cutting depth.

5. The ball end mill cutting method according to any one of claims 2 to 4,
wherein the tilt angle of the ball end mill is set to 45°,
a rotating speed is set substantially to 20000 rpm, and
a feed speed is set in a range from 1 to 8 μm/sec.

6. The ball end mill cutting method according to claim 5,
wherein the curvature radius of the ball end mill is set to 200 μm, and
the cutting depth is set in a range from 15 to 20 μm.

7. A square end mill cutting method comprising a step of:
cutting a work made of any of a glassy inorganic material and a hard, brittle inorganic material without causing damage while rotating a super-hard square end mill including cutting blades each having a rectangle and a spiral angle at a feed speed for each of the cutting blades in a range from 4.8 to 6 nm/edge.

8. The square end mill cutting method according to claim 7,
wherein the cutting operation is performed in water.

9. The square end mill cutting method according to any one of claims 7 and 8,
wherein a feed speed is set equal to or below 0.24 mm/min when a rotating speed of the square end mill is set to 20000 rpm.

10. The square end mill cutting method according to any one of claims 7 and 8,
wherein a rotating speed is set equal to or above 50000 rpm when the feed speed is set to 0.48 mm/min.

11. The square end mill cutting method according to any one of claims 7, 8, 9, and 10,
wherein the square end mill comprises a cubic boron nitride (cBN) tool.
